(19) United States
(12) Patent Application Publication
(10) Pub. No.: US 2014/0340706 A1
(43) Pub. Date: Nov. 20, 2014

(54) COOPERATIVE IMAGE PROCESSING SYSTEM, PORTABLE TERMINAL APPARATUS, COOPERATIVE IMAGE PROCESSING METHOD, AND RECORDING MEDIUM

(71) Applicant: KONICA MINOLTA, INC., Chiyoda-ku (JP)

(72) Inventor: Atsushi KONDO, Itami-shi (JP)

(73) Assignee: KONICA MINOLTA, INC., Chiyoda-ku (JP)

(21) Appl. No.: 14/272,657

(22) Filed: May 8, 2014

(30) Foreign Application Priority Data
May 14, 2013 (JP) 2013-102631

(51) Int. Cl. G06F 3/12

(52) U.S. Cl. CPC G06F 3/1253; G06F 3/1292; G06F 3/1203
USPC 358/1.15

(57) ABSTRACT

A cooperative image processing system includes an image processing apparatus and a portable terminal apparatus. The image processing apparatus includes a transmitter that transmits operation screen display data for reproducing an operation screen of the image processing apparatus to the portable terminal apparatus. The portable terminal apparatus includes: a receiver that receives the operation screen display data; a display portion that displays the operation screen on the basis of the operation screen display data received by the receiver; a console that accepts a user gesture instruction; a memory that records a predetermined conversion rule; a converter that converts the user gesture instruction input via the console, into operation information in accordance with the conversion rule stored on the memory; and a transmitter that transmits the operation information obtained by the converter. The image processing apparatus further comprises a controller that performs an operation being matching the operation information received therefrom.

This application claims priority under 35 U.S.C. §119 to Japanese Patent Application No. 2013-102631 filed on May 14, 2013, the entire disclosure of which is incorporated herein by reference in its entirety.

### BACKGROUND OF THE INVENTION

1. Field of the Invention

The present invention relates to: a cooperative image processing system that includes an image processing apparatus such as a multi-function peripheral (MFP), i.e., a multifunctional digital machine and a portable terminal apparatus such as a smartphone or a tablet computer terminal; the portable terminal apparatus employed in the cooperative image processing system; a cooperative image processing method for the cooperative image processing system; and a recording medium storing an cooperative image processing program.

2. Description of the Related Art

The following description sets forth the inventor's knowledge of related art and problems therein and should not be construed as an admission of knowledge in the prior art.

In recent years, users can store digital documents on their portable information apparatuses such as smartphones and tablet computer terminals, and even view and edit the stored documents anytime and anywhere they like. After editing a document by their portable terminal apparatuses, users can transmit the document to an image processing apparatus such as an MFP to print by or store on the image processing apparatus. Users also can create a file consisting of image data or other data, by scanning a physical paper document with a scanner of the image processing apparatus, and transmit the file to their portable information apparatuses to edit by their portable terminal apparatuses.

However, users are bothered by the need to operate different screens on the image processing apparatus and the portable information apparatus, back and forth separately, which is quite troublesome.

As a solution to such a problem, there is a proposed cooperative system comprising an image processing apparatus and a portable terminal apparatus, which allows users to access functions of the image processing apparatus from the portable terminal apparatus, via an operation screen of the image processing apparatus which is displayed as a remote screen on a display portion of the portable terminal apparatus. In this cooperative system, a remote screen of the image processing apparatus is displayed on the display portion of the portable terminal apparatus on the basis of screen data received from the image processing apparatus.

More specifically, the portable terminal apparatus transmits information indicating that an operation is performed, to the image processing apparatus; the image processing apparatus generates screen data for reproducing another screen on the basis of the information and transmits it to the portable terminal apparatus; the portable terminal apparatus updates the remote screen on the basis of the screen data.

The portable terminal apparatus has a touch panel; users can proceed to a next page and return to a previous page by performing a gesture such as a flick gesture on a screen displayed on the touch panel.

However, when a user gives an instruction for forward or backward page turning by performing a gesture on a remote screen of the image processing apparatus which is displayed on the portable terminal, the following problem can be caused.

Japanese Unexamined Patent Publication No. 2007-010645 suggests a map display apparatus that is allowed to reduce input errors in response to user only slightly touching on a touch panel and user scrolling on a touch panel with the finger.

More specifically, the map display apparatus is provided with: a display portion 3 capable of displaying a map on a screen; a touch panel 10 capable of detecting a touch on the screen at a predetermined interval period; a microcomputer 8 that changes the detection interval period of the touch panel 10 such that the touch panel 10 can detect a touch at a second interval period that is longer than a first interval period after detecting a touch at the first interval period; and a controller circuit 6 that allows a map on the display portion 3 to be scrolled, depending on the detection result of the touch panel 10.

Still more specifically, as illustrated in FIGS. 15A and 15B, users display an address settings screen including a plurality of address selecting buttons 301 as a remote screen, when intending to transmit document data by e-mail from the image processing apparatus. The address settings screen is composed of two pages; when a user presses a next page button 303 on Page 1 of the address settings screen as illustrated in FIG. 15A, the image processing apparatus transmits data for reproducing Page 2 of the address settings screen as illustrated in FIG. 15B, to the portable terminal apparatus, so that the portable terminal apparatus can display that page.

In this situation, the user sometimes performs a downward flick gesture as indicated by an arrow and a finger icon on Page 1 of the address settings screen of FIG. 15A. Usually, the user hopes to go to Page 2 of the address settings screen of FIG. 15B by doing so. If not having a gesture-enabled algorithm, the image processing apparatus would wrongly judge that the user presses an address button 301a (as indicated by hatching in FIG. 16) that is first touched with a downward flick gesture, thus the portable terminal apparatus transmits an e-mail message to the corresponding address, which is an unsolved problem.

As a matter of course, providing a gesture-enabled algorithm to the image processing apparatus can solve such a problem as mentioned above; however, it can also cause the need for software changes on the image processing apparatus, an increase in costs, and other problems.

Unfortunately, the invention described in Japanese Unexamined Patent Publication No. 2007-010645 does not bring an effective solution to the above-mentioned problem which can be caused when such a gesture is performed.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

A first aspect of the present invention relates to a cooperative image processing system including an image processing apparatus and a portable terminal apparatus, the image processing apparatus and the portable terminal apparatus being capable of connecting to each other,

the image processing apparatus including a transmitter that transmits operation screen display data for reproducing an operation screen of the image processing apparatus to the portable terminal apparatus to allow the portable terminal apparatus to reproduce the operation screen, the portable terminal apparatus being connected to the image processing apparatus,

the portable terminal apparatus including:

a receiver that receives the operation screen display data from the image processing apparatus;

a display portion that displays the operation screen of the image processing apparatus on the basis of the operation screen display data received by the receiver;

a console that accepts a user gesture instruction as input;

a memory that records a predetermined conversion rule in accordance with which the user gesture instruction input via the console can be converted into operation information about the operation screen of the image processing apparatus, the operation screen displayed on the display portion;

a converter that converts the user gesture instruction into operation information about the operation screen of the image processing apparatus in accordance with the conversion rule, when the user gesture instruction is input via the console while the operation screen is displayed on the display portion; and

a transmitter that transmits the operation information about the operation screen,

the operation information being obtained by the converter, the image processing apparatus further including a controller that performs an operation being matching the operation information, the operation information being received from the portable terminal apparatus.

A second aspect of the present invention relates to a cooperative image processing system including an image processing apparatus and a portable terminal apparatus, the image processing apparatus and the portable terminal apparatus being capable of connecting to each other,

the image processing apparatus including a transmitter that transmits operation screen display data for reproducing an operation screen of the image processing apparatus or a plurality of pages composing the operation screen to the portable terminal apparatus to allow the portable terminal apparatus to reproduce the operation screen or the pages, respectively, the portable terminal apparatus being connected to the image processing apparatus,

the portable terminal apparatus including:

a receiver that receives the operation screen display data from the image processing apparatus;

a display portion that displays the operation screen of the image processing apparatus on the basis of the operation screen display data received by the receiver;

a console that accepts a user gesture instruction as input;

a screen reproduction portion that reproduces another page on the display portion as prompted by the user gesture instruction, on the basis of the operation screen display data for reproducing the pages, the operation screen display data being received from the image processing apparatus, when the user gesture instruction is input via the console while any one of the pages is displayed on the display portion; and

a transmitter that transmits operation information indicating a button pressing to the image processing apparatus, when an operation button is pressed on the operation screen displayed on the display portion, the image processing apparatus further including a controller that performs an operation being matching the operation information, the operation information being received from the portable terminal apparatus.

A third aspect of the present invention relates to a cooperative image processing method to be implemented by a cooperative image processing system, the cooperative image processing system including an image processing apparatus and a portable terminal apparatus, the image processing apparatus and the portable terminal apparatus being capable of connecting to each other,

the cooperative image processing method including the following step of the image processing apparatus: transmitting operation screen display data for reproducing an operation screen of the image processing apparatus to the portable terminal apparatus to allow the portable terminal apparatus to reproduce the operation screen,

the portable terminal apparatus including:

a display portion;

a console that accepts a user gesture instruction as input; and

a memory that records a predetermined conversion rule in accordance with which the user gesture instruction input via the console can be converted into operation information about the operation screen of the image processing apparatus, the operation screen being displayed on the display portion,

the cooperative image processing method further including the following steps of the portable terminal apparatus:

receiving the operation screen display data from the image processing apparatus;

displaying the operation screen of the image processing apparatus on the display portion on the basis of the operation screen display data received therefrom;

converting the user gesture instruction into operation information about the operation screen of the image processing apparatus in accordance with the conversion rule, when the user gesture instruction is input via the console while the operation screen is displayed on the display portion; and

transmitting the operation information about the operation screen, the operation information being obtained as a result of the conversion,

the cooperative image processing method further including the following step of the image processing apparatus: performing an operation being matching the operation information, the operation information being received from the portable terminal apparatus.

A fourth aspect of the present invention relates to a cooperative image processing method to be implemented by a cooperative image processing system, the cooperative image processing system including an image processing apparatus and a portable terminal apparatus, the image processing apparatus and the portable terminal apparatus being capable of connecting to each other,

the cooperative image processing method including the following step of the image processing apparatus:

transmitting operation screen display data for reproducing an operation screen of the image processing apparatus or a plurality of pages composing the operation screen, to the portable terminal apparatus to allow the portable terminal apparatus to reproduce the operation screen or the pages, respectively, the portable terminal apparatus being connected to the image processing apparatus,

the cooperative image processing method including the following steps of the portable terminal apparatus:

receiving the operation screen display data from the image processing apparatus;

displaying the operation screen of the image processing apparatus on a display portion on the basis of the operation screen display data received therefrom;

reproducing another page on the display portion as prompted by a user gesture instruction, on the basis of the operation screen display data for reproducing the pages, the operation screen display data being received from the image processing apparatus, when the user gesture instruction is input via a console while any one of the pages is displayed on the display portion; and

transmitting operation information indicating a button pressing to the image processing apparatus, when an operation button is pressed on the operation screen displayed on the display portion,

the cooperative image processing method further including the following step of the image processing apparatus: performing an operation being matching the operation information, the operation information being received from the portable terminal apparatus.

A fifth aspect of the present invention relates to a portable terminal apparatus including:

a connecting portion that connects the portable terminal apparatus to an image processing apparatus;

a receiver that receives operation screen display data for reproducing an operation screen of the image processing apparatus from the image processing apparatus to which the portable terminal apparatus is connected by the connecting portion;

a display portion that displays the operation screen of the image processing apparatus on the basis of the operation screen display data received by the receiver;

a console that accepts a user gesture instruction as input;

a memory that records a predetermined conversion rule in accordance with which the user gesture instruction input via the console can be converted into operation information about the operation screen of the image processing apparatus, the operation screen displayed on the display portion;

a converter that converts the user gesture instruction into operation information about the operation screen of the image processing apparatus in accordance with the conversion rule, when the user gesture instruction is input via the console while the operation screen is displayed on the display portion; and

a transmitter that transmits the operation information about the operation screen, the operation information being obtained by the converter.

A sixth aspect of the present invention relates to a non-transitory computer-readable recording medium storing a cooperative image processing program for a computer of a portable terminal apparatus,

the portable terminal apparatus including:

a display portion;

a console that accepts a user gesture instruction as input; and

a memory that records a predetermined conversion rule in accordance with which the user gesture instruction input via the console can be converted into operation information about an operation screen of an image processing apparatus, the operation screen being displayed on the display portion,

the cooperative image processing program to make the computer execute:

connecting the portable terminal apparatus to the image processing apparatus;

receiving operation screen display data for reproducing the operation screen of the image processing apparatus from the image processing apparatus to which the portable terminal apparatus is connected;

displaying the operation screen of the image processing apparatus on the display portion on the basis of the operation screen display data received therefrom;

converting the user gesture instruction into operation information about the operation screen of the image processing apparatus in accordance with the conversion rule, when the user gesture instruction is input via the console while the operation screen is displayed on the display portion; and

transmitting the operation information about the operation screen, the operation information being obtained as a result of the conversion.

A seventh aspect of the present invention relates to a portable terminal apparatus including:

a connecting portion that connects the portable terminal apparatus to an image processing apparatus;

a receiver that receives operation screen display data for reproducing an operation screen of the image processing apparatus or a plurality of pages composing the operation screen from the image processing apparatus, the image processing apparatus being connected to the portable terminal apparatus;

a display portion that displays the operation screen of the image processing apparatus on the basis of the operation screen display data received by the receiver;

a console that accepts a user gesture instruction as input;

a screen reproduction portion that reproduces another page on the display portion as prompted by the user gesture instruction, on the basis of the operation screen display data for reproducing the pages, the operation screen display data being received from the image processing apparatus, when the user gesture instruction is input via the console while any one of the pages is displayed on the display portion; and

a transmitter that transmits operation information indicating a button pressing to the image processing apparatus, when an operation button is pressed on the operation screen displayed on the display portion.

A eighth aspect of the present invention relates to a non-transitory computer-readable recording medium storing a cooperative image processing program to make a computer of a portable terminal apparatus execute:

connecting the portable terminal apparatus to an image processing apparatus;

receiving operation screen display data for reproducing an operation screen of the image processing apparatus or a plurality of pages composing the operation screen from the image processing apparatus, the image processing apparatus being connected to the portable terminal apparatus;

displaying the operation screen of the image processing apparatus on a display portion on the basis of the operation screen display data received therefrom;

reproducing another page on the display portion as prompted by a user gesture instruction, on the basis of the operation screen display data for reproducing the pages, the operation screen display data being received from the image processing apparatus, when the user gesture instruction is input via a console while any one of the pages is displayed on the display portion; and

transmitting operation information indicating a button pressing to the image processing apparatus, when an operation button is pressed on the operation screen displayed on the display portion.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 illustrates a configuration of a cooperative image processing system including a portable terminal apparatus according to one embodiment of the present invention;

FIG. 2 is a block diagram illustrating an electrical configuration of an image processing apparatus and a portable terminal apparatus;

FIG. 3 is a block diagram illustrating a firmware configuration of the image processing apparatus and the portable terminal apparatus;

FIG. 4 is a view illustrating relationships among application software portions of the image processing apparatus and the portable terminal apparatus;

FIG. 5 is an example of a remote screen on a display portion of the portable terminal apparatus;

FIG. 6 is a view illustrating a screen to be displayed next when a gesture is performed on a remote screen of FIG. 5;

FIG. 7 illustrates tables stored on the portable terminal apparatus;

FIG. 8 is a flowchart representing information exchanges between the image processing apparatus and the portable terminal apparatus;

FIG. 9 is a flowchart representing an operation of the portable terminal apparatus;

FIG. 10 illustrates a table used in another embodiment of the present invention;

FIG. 11 is a flowchart representing information exchange between the image processing apparatus and the portable terminal apparatus in the embodiment of FIG. 10;

FIG. 12 is a flowchart representing an operation of the information processing apparatus;

FIG. 13 is a flowchart representing an operation of the portable terminal apparatus, which is performed when data is received;

FIG. 14 is a flowchart representing an operation of the portable terminal apparatus, which is performed when a gesture is performed;

FIGS. 15A and 15B illustrate screens to explain a conventional problem; and

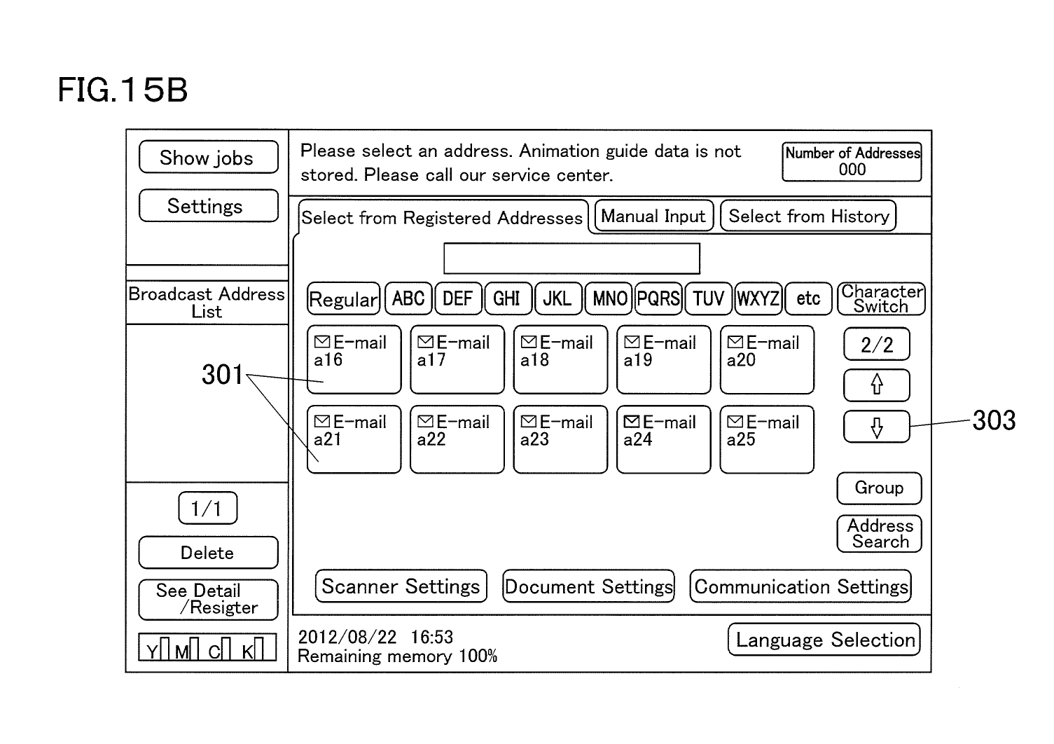

FIG. 16 illustrates another screen to explain a conventional problem.

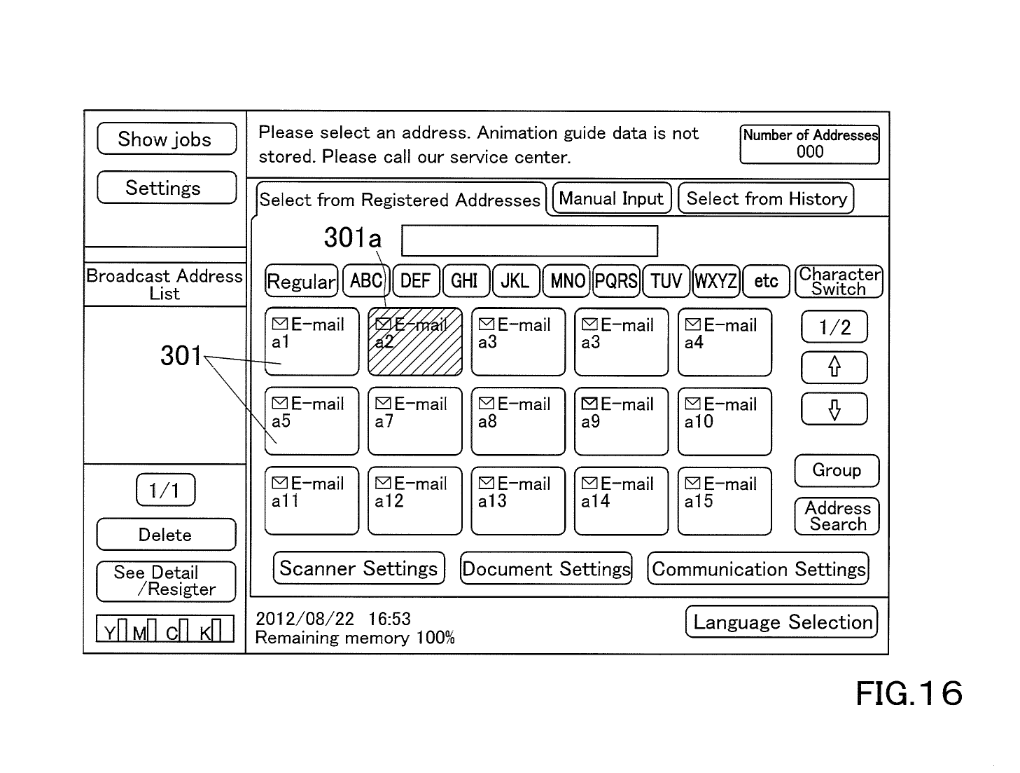

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinafter, some embodiments of the present invention will be described in combination with the accompanying drawings.

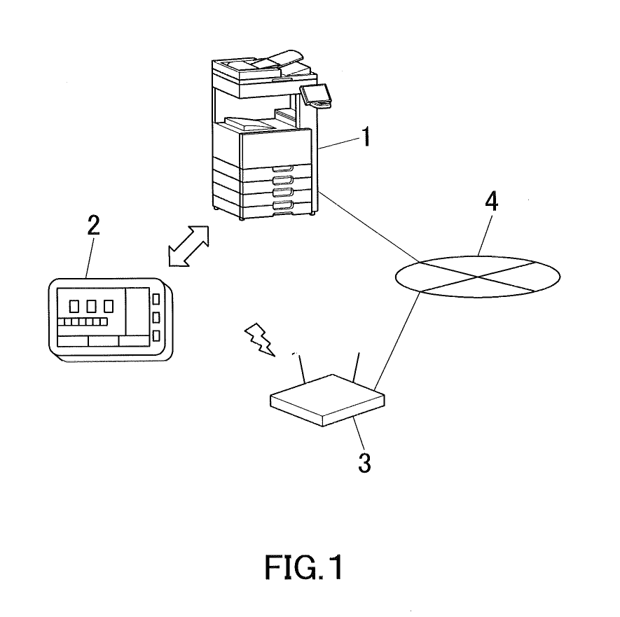

FIG. 1 illustrates a configuration of a cooperative image processing system including a portable terminal apparatus according to one embodiment of the present invention.

The cooperative image processing system is provided with an image processing apparatus 1, a portable terminal apparatus 2, and others; the image processing apparatus 1 and the portable terminal apparatus 2 can be connected to each other via a wireless LAN router 3 and a network 4. In this embodiment, they are connected to each other in a wireless manner, although the image processing apparatus 1 and the portable terminal apparatus 2 also can be connected in a wired manner, via an USB interface for example.

In this embodiment, an MFP, which has various functions such as a copier function, a printer function, a scanner function, and a facsimile function, as described above, is employed as the image processing apparatus 1. Hereinafter, the image processing apparatus will also be referred to as “MFP”. The portable terminal apparatus will also be referred to as “portable terminal”.

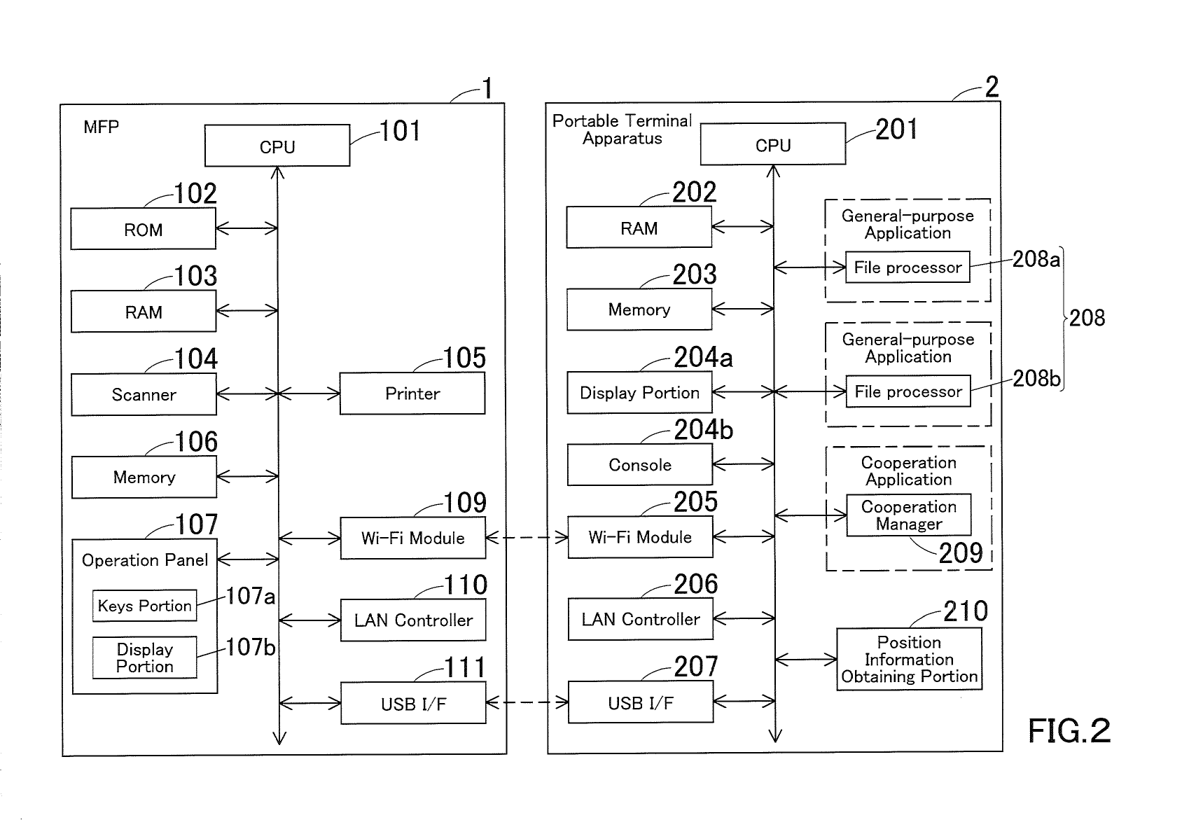

FIG. 2 is a block diagram illustrating an electrical configuration of the MFP 1 and the portable terminal 2.

The MFP 1 is provided with: a CPU 101; a ROM 102; a RAM 103; a scanner 104; a printer 105; a memory 106; an operation panel 107; a Wireless Fidelity module (Wi-Fi module) 109; a Local Area Network controller (LAN controller) 110; and an USB interface (USB I/F) 111.

The CPU 101 controls the entire MFP 1 in a unified and systematic manner in accordance with operation programs stored on a memory such as the ROM 102. Specifically, in this embodiment, in addition to enabling various functions of the MFP 1, the CPU 101 controls the following operations, for example: transmitting operation screen display data for reproducing an operation screen of the MFP 1 to the portable terminal 2 as requested by the portable terminal 2 so that the operation screen will be displayed on the portable terminal 2; and performing job execution or transmitting operation screen display data for reproducing another operation screen of the MFP 1, in response to user operation on the portable terminal 2.

The ROM 102 is a memory storing operation programs and others for the CPU 101; the RAM 103 is a memory providing a work area for the CPU 101 to execute processing in accordance with operation programs.

The scanner 104 reads images on a document that is put on a platen glass or in an automatic document feeder not shown in the figure and outputs scanned image data that is electronic data.

The printer 105 prints image data of a document scanned by the scanner 104 and print data received from the portable terminal 2 and others, on sheets of paper.

The memory 106, which consists of a hard disk device, stores various types of data, applications, and others. Specifically, in this embodiment, the memory 106 stores screen display data for reproducing various operation screens to be displayed on the operation screen 107; the CPU 101 calls display data for reproducing an appropriate operation screen for the user operation, out of the memory 106, and displays the operation screen on the operation panel 107 or transmits the screen display data to the portable terminal 2. The memory 106 further stores a plurality of files such as document files consisting of images scanned by the scanner 104 and document files received from external apparatuses.

The operation panel 107 allows users to operate the MFP 1 while displaying messages and others thereon. The operation panel 107 is provided with: a keys portion 107a having a Start key and numeric keys; and a display portion 107b consisting of a liquid-crystal display for example, with touch-panel functionality.

The Wi-Fi module 109 is an interface supporting wireless access to the portable terminal 2; the LAN controller 110 controls the communication with external apparatuses such as personal computer terminals and other MFPs.

The USB interface 111 is an interface supporting wired access to the portable terminal 2.

Meanwhile, the portable terminal 2 consists of a smartphone, a tablet computer terminal, electronic paper, and others. The portable terminal 2 is provided with: a CPU 201; a RAM 202; a memory 203; a display portion 204a; a console 204b; a Wi-Fi module 205; a LAN controller 206; an USB interface 207; file processors 208a and 208b; and a cooperation manager 209.

The CPU 201 controls the entire portable terminal 2 in a unified and systematic manner in accordance with an Operating System (OS), which is basic software, and general-purpose applications.

The RAM 202 is a memory providing a work area for the CPU 201 to execute processing in accordance with operation programs.

The memory 203, which consists of a hard disk device, stores various types of data, applications, and others. Specifically, in this embodiment, the memory 203 stores: operation screen display data received from the MFP 1; and programs such as a basic OS, a cooperation application, and general-purpose applications. Hereinafter, applications also will be referred to simply as “app”.

The display portion 204a consists of a liquid-crystal device for example; the console 204b, which is provided on the display portion 204, consists of a touch panel enabling touch input. Generally, a touch input is a gesture that defines an operation depending on the number of fingers used and the movement of the fingers. The following are examples of gesture: flick gesture for screen scroll (forward or backward page turning); and pinch-in and pinch-out gesture for changing image size (zoom-in and zoom-out) or for image rotation.

The Wi-Fi module 205 is an interface for establishing a wireless connection between the MFP 1 and the portable terminal 2; the LAN controller 206 controls communication with external apparatuses such as user terminals. The USB interface 207 is an interface for establishing a wired connection between the MFP 1 and the portable terminal apparatus 2.

The file processors 208a and 208b perform file editing, file transfer, e-mail delivery, and other operations. Hereinafter, the file processors 208a and 208b will be referred to as “file processor 208”.

The cooperation manager 209 supports access to functions of the MFP 1 in order to achieve smooth functional cooperation between the MFP 1 and the portable terminal 2. More specifically, in order to access functions of the MFP 1 such as a copier function, a printer function, a scanner function, and a facsimile function, the cooperation manager 209 performs the following operations: receiving operation screen display data for reproducing an operation screen displayed on the operation panel 107 of the MFP 1, from the MFP 1; displaying the operation screen on the display portion 204 as a remote screen; detecting the coordinate of a touch position when a user presses a button on the remote screen; and transmitting the coordinate to the MFP 1 as operation information. The MFP 1 identifies the user instruction by analyzing the coordinate of the touch position and executes processing accordingly.

In this embodiment, the operation panel 107 of the MFP 1 does not support multi-touch gestures. The MFP 1 therefore cannot detect a gesture performed on the remote screen on the display portion 204a.

As a solution to the concern, a conversion rule, in accordance with which a gesture instruction input via the display portion 204a can be converted into operation information about the operation screen of the MFP 1, is created in advance. The conversion rule will be later described in detail. The conversion rule is stored on the memory 203.

The file processor 208 is enabled to execute its functions when the CPU 201 activates a general-purpose application. The general-purpose application is software to enable the file processor 208 to execute processing on various files; there are various types of general-purpose application such as file editing applications, applications having a function of transmitting files by electronic mail; and applications having a function of storing files on a Web server.

The cooperation manager 209 is enabled to execute its functions when the CPU 201 activates a cooperation application. The cooperation application is software to achieve smooth functional cooperation between the MFP 1 and the portable terminal 2. The general-purpose application and the cooperation application are allowed to transfer files to each other and download files from each other.

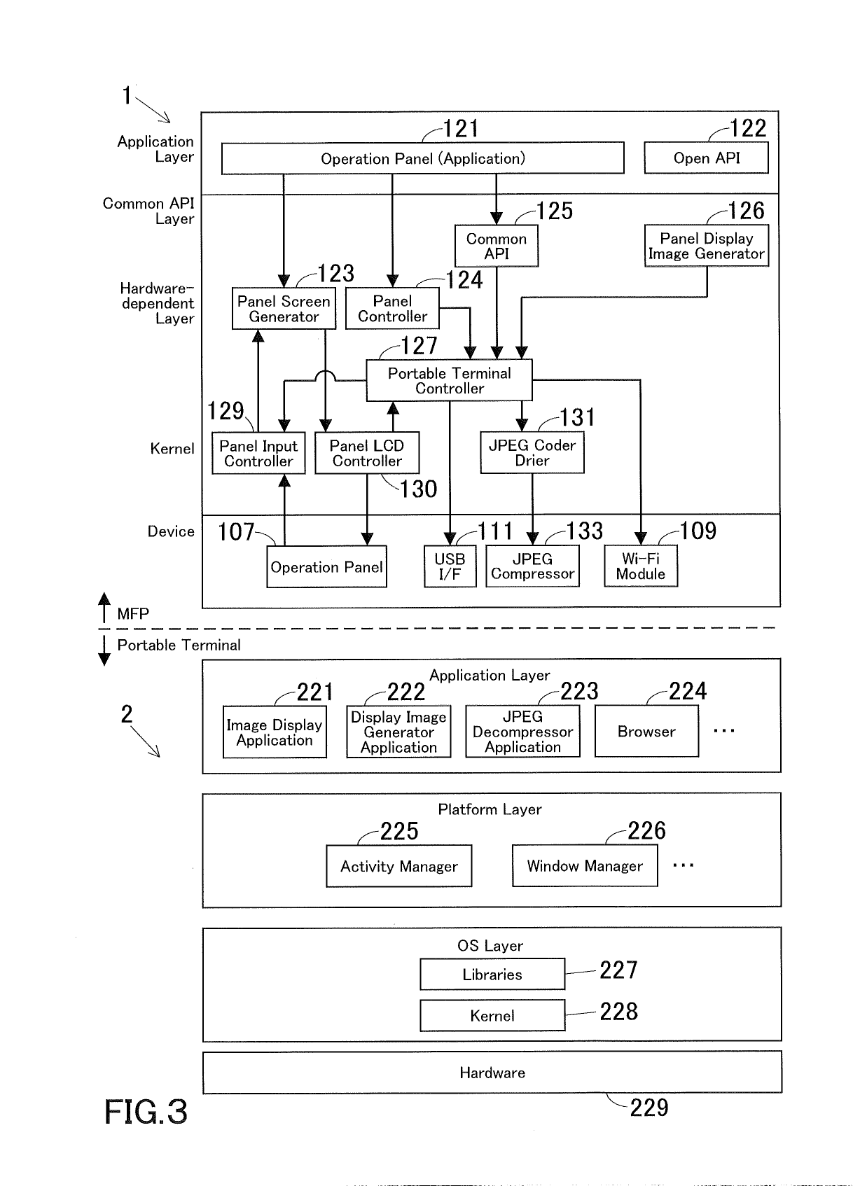

FIG. 3 is a block diagram illustrating a firmware configuration of the MFP 1 and the portable terminal 2.

The MFP 1 has: an application layer including an operation panel (application) 121, an open application program interface (open API) 122, and others; a common API layer including a common application program interface (common API) 125, a panel display image generator 126, and others; and a hardware-dependent layer including a panel screen generator 123, a panel controller 124, a portable terminal controller 127, and others.

The MFP 1 also has: a kernel layer including a panel input controller 129, a panel LCD controller 130, a JPEG coder driver 128, and others; and a device layer including an operation panel 107, an USB interface 111, a JPEG compressor 133, a Wi-Fi module 109, and others.

The panel screen generator 123 generates screen display data for reproducing a screen displayed on the operation panel 107 of the MFP 1, when a user performs a cooperation operation on the portable terminal 2.

The panel controller 124 controls the conditions of communication with the operation panel 107 and also controls and others; the portable terminal controller 127 controls an interface for communicating with the portable terminal 2 and also controls others under the cooperation between the MFP 1 and the portable terminal 2.

The panel input controller 129 performs control of inputs via the operation panel 107; the panel LCD controller 130 performs display control of the display portion 107b of the operation panel 107. The JPEG compressor 133 compresses operation screen display data and others received from the portable terminal controller 127 by way of the JPEG coder driver 131, into JPEG form; the JPEG compressor 133 transmits the compressed data to the portable terminal 2 by way of the USB interface 111 and the Wi-Fi module 109.

Meanwhile, the portable terminal 2 consists of: an application layer including an image display application 221, an display image generator application 222, a JPEG decompressor application 223, and various applications such as a browser; a platform layer including various managers 225 and 226 and others; an OS layer including various libraries 227 and a kernel 228; and hardware 229.

The JPEG decompressor application 223 decompresses the compressed data received from the MFP 1.

A series of pages can be displayed one after another on a remote screen of the display portion 204 of the portable terminal 2; in such a case, when a user performs a gesture such as a flick gesture on a remote screen, the display image generator application 222 reproduces a next page or a previous page on the basis of operation screen display data stored on the memory 203 to make it show on the display portion 204. This operation will be later described in detail in another embodiment of the present invention.

The image display application 221 reproduces an operation screen of the MFP 1 on the display portion 204a as a remote screen on the basis of operation screen display data received from the MFP 1, after the operation screen display data is decompressed by the JPEG decompressor application 223.

In this embodiment, the image display application 221, the display image generator application 222, and the JPEG decompressor application 223 are configured to achieve one of the functions of the cooperation application.

Hereinafter, operations of the MFP 1 and the portable terminal 2, which are performed under the cooperation between them, will be described.

Here, a user is trying to establish a wireless network access to the MFP 1 from the portable terminal 2 to perform operations under the cooperation between the MFP 1 and the portable terminal 2. The user starts the cooperation between the MFP 1 and the portable terminal 2 by activating a cooperation application installed on the portable terminal 2.

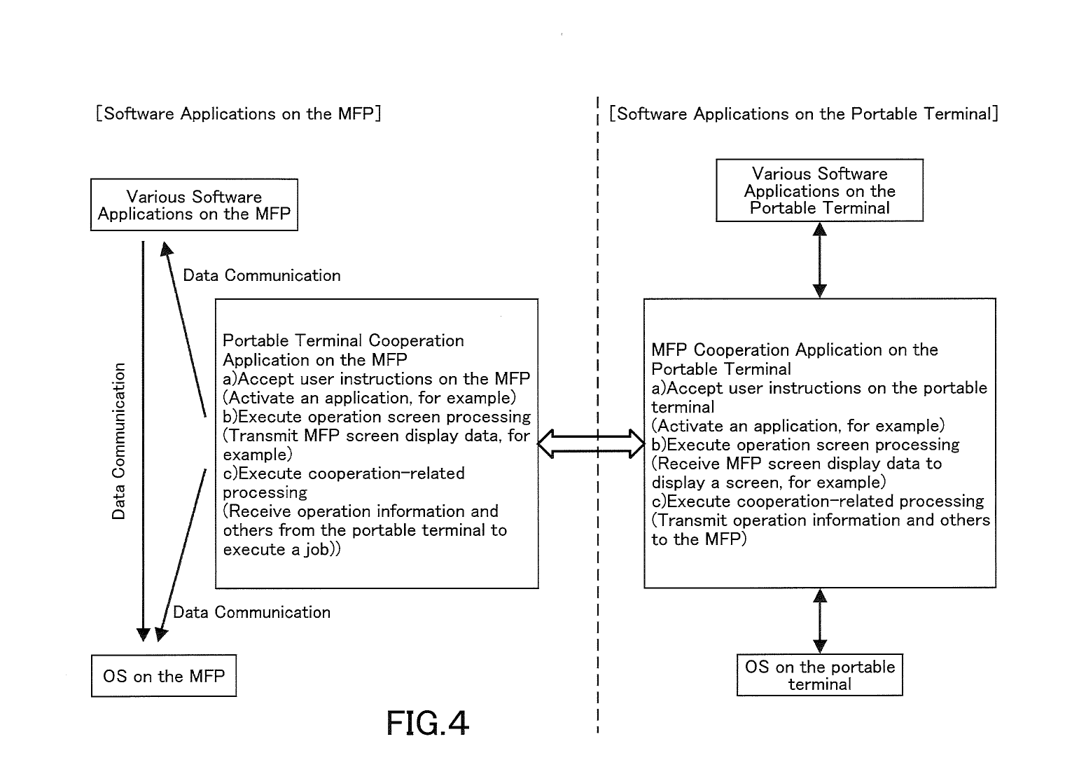

FIG. 4 illustrates relationships among software applications of the MFP 1 and the portable terminal 2; the software applications of the MFP 1 are shown on the left side and the software applications of the portable terminal 2 are shown on the right side.

The cooperation application of the portable terminal 2 is positioned between an OS of the portable terminal 2 and software applications that are general-purpose software; the cooperation application is allowed to: receive data from the MFP 1; execute processing on the received data; obtain operation information of users and operation screen display data of the portable terminal 2; and transmit the obtained data to the MFP 1 when needed. More specifically, the cooperation application of the portable terminal 2 accepts user instructions on the portable terminal 2, for example, accepts user instructions to activate an application, receives operation screen display data of the MPF 1 and displays a screen (executes operation screen processing on the portable terminal), and executes cooperation-related processing and other processing. The cooperation-related processing is, for example, transmitting operation information indicating details of user operation, to the MFP 1.

If the MFP 1 is allowed to obtain all necessary information anytime because its OS and its software applications are all designed or customized in-house, the cooperation application of the MFP 1 does not necessarily have to be positioned between OS and software applications, i.e.; the cooperation application of the MFP 1, which is completely independent of the OS and the software applications, can obtain all necessary information by communicating with the OS and the software applications. The cooperation application of the MFP 1 accepts user instructions on the MFP 1, for example, instructions for activating an application; transmits screen display data for reproducing a screen of the MFP 1 (executes operation screen processing on the MFP); and executes cooperation-related processing and other processing. The cooperation-related processing is, for example, receiving operation information and others from the portable terminal 2 and executing a job.

When a user gives an instruction to start the MFP cooperation by touching a cooperation icon on the display portion 204 of the portable terminal 2, the cooperation application of the portable terminal 2 activates the cooperation application of the MFP 1 and transmits a request for operation screen display data, by communicating with the MFP 1 that is registered in advance. Subsequently, the cooperation mode is turned on; an operation screen of the MFP 1 is displayed both on the display portion 105a of the MFP 1 and the display portion 204 of the portable terminal 2. Here, the operation screen does not necessarily have to be displayed on the display portion 105a of the MFP 1.

Hereinafter, operation screen display data to be transmitted to the portable terminal apparatus 2 from the MFP 1 will be described in detail.

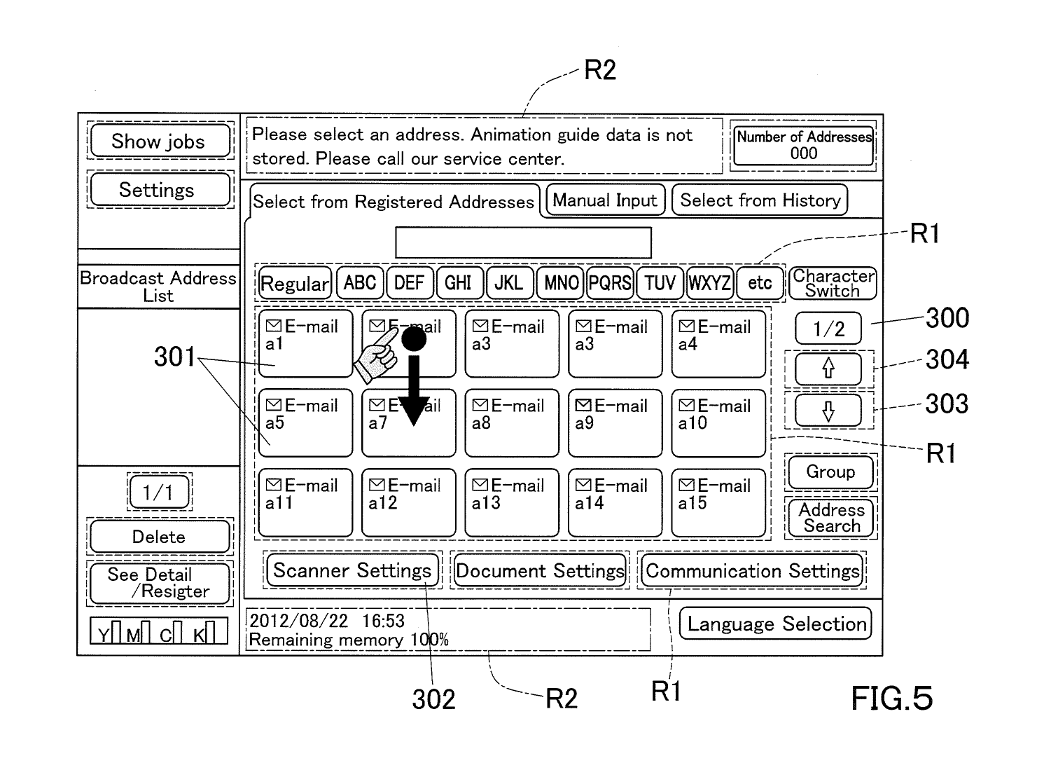

As illustrated in FIG. 5, an operation screen of the MFP 1 is composed of: a base screen data object 300 for reproducing a base screen that is a background image; and part image data objects that are part images to be arranged on a base screen such as address settings buttons 301, a scan settings button 302, a next page button 303, and a previous page button 304.

When it is necessary, the MFP 1 transmits information such as the base screen data objects 300, the part image data objects that are part images to be arranged on a base screen, identification information (ID) of each data object, and position information of the part image data objects, so that the portable terminal 2 can display an operation screen on the display portion 204a.

These information may be sent each time, but it is preferred that the MFP 1 transmit in advance the base screen data objects 300 and IDs thereof to the portable terminal 2 and the portable terminal 2 store them in advance on the memory 203. In such a case, when it is necessary, the MFP 1 transmits an ID of a base screen data object 300 for reproducing a target base screen, part image data objects that are part images, and position information of the part image data objects to the portable terminal 2, and the portable terminal 2 reproduces an operation screen by arranging the part images on the target base screen. In this configuration, the MFP 1 does not have to transmit a base screen data object 300 every time it is necessary, which would contribute to a smooth traffic flow between the MFP 1 and the portable terminal 2.

Hereinafter, an operation of the cooperative image processing system of FIG. 1 will be further described.

Here, as illustrated in FIG. 5, the portable terminal 2 displays one of a plurality of pages, which compose an operation screen, on the display portion 204a as a remote screen. In the example of FIG. 5, it is an e-mail address settings screen, on which a plurality of the address settings buttons 301 are arranged. A next address settings screen will be displayed with a pressing of the next page button 303; a previous address settings screen will be displayed with a pressing of the previous page button 304.

In this situation, a user sometimes performs a flick gesture, which is supported by the portable terminal 2, as indicated by a finger icon and an arrow on the address settings screen of FIG. 5. If not being gesture-enabled, the MFP 1 would wrongly judge that the user presses a button that is first touched with the finger.

As a solution to such a problem, the flick gesture is converted to a button pressing on the operation screen in this embodiment. The conversion is performed in accordance with the above-mentioned conversion rule. In this embodiment, the conversion rule defines relationships among the following elements: a finger travel distance and a finger moving direction which are calculated from a flick starting point and a flick ending point; whether to turn pages forward or backward; and the number of pages to turn forward or backward.

More specifically, the portable terminal 2 would identify the gesture as a button pressing if the finger travel distance is not greater than 50 dots and would identify the gesture as a flick gesture (a scrolling gesture) if the finger travel distance is greater than 50 dots. Here, every finger travel distance of 50 dots is convertible to one page to turn, and accordingly the portable terminal 2 would convert a finger travel distance of greater than 50 dots but not greater than 100 dots to one page to turn, and would convert a finger travel distance of greater than 100 dots but not greater than 150 dots to two pages to turn if the operation screen is composed of three or more pages. The portable terminal 2 would identify the gesture as a forward page turning if the finger moving direction is downward and would identify the gesture as a backward page turning if the finger moving direction is upward. Therefore, when the finger moves 70 dots downward for example, the portable terminal 2 would identify the gesture as turning one page forward.

The travel distance and the moving direction are related to the next page button 303 and the previous page button 304 on the operation panel. Identifying the gesture as a forward page turning, i.e., a pressing of the next page button 303, the portable terminal 2 converts it into operation information that is position information (coordinate) of the next page button 303; identifying the gesture as a backward page turning, i.e., a pressing of the previous page button 304, the portable terminal 2 converts it into operation information that is position information (coordinate) of the previous page button 304. The portable terminal 2 then transmits the operation information to the MFP 1.

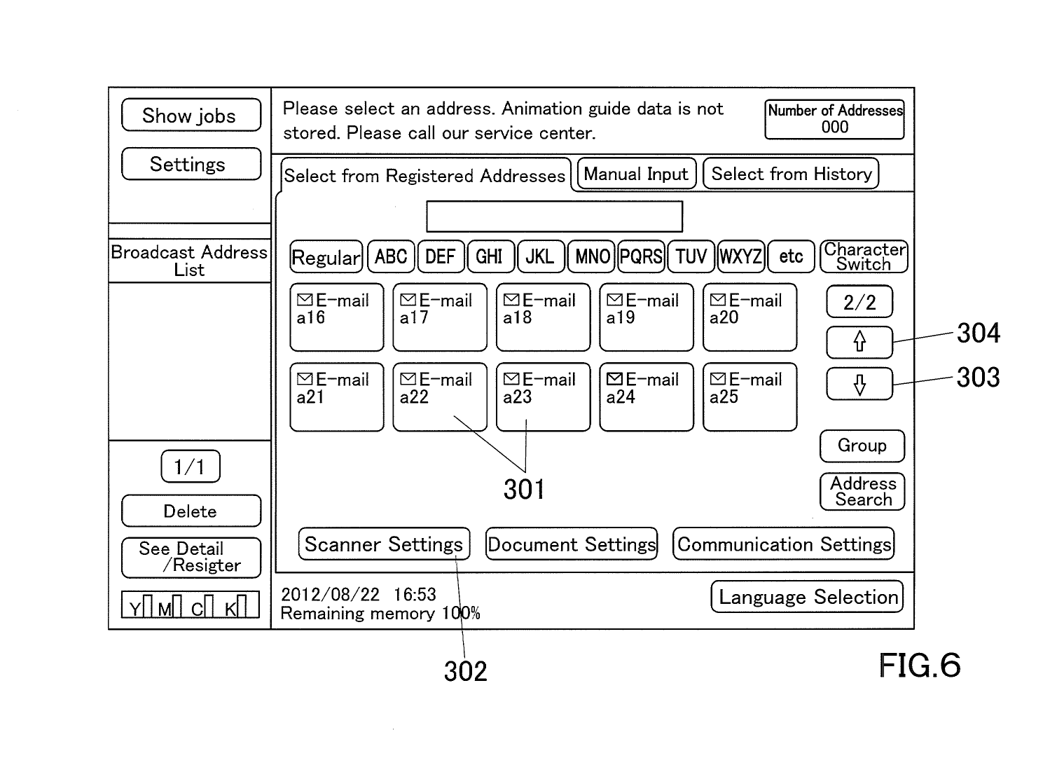

In return to the operation information, the MFP 1 transmits operation screen display data for reproducing a next page in response to a pressing of the next page button 303 or reproducing a previous page in response to a pressing of the previous page button 304, to the portable terminal 2. The portable terminal 2 displays an updated remote screen as illustrated in FIG. 6 on the basis of the operation screen display data received therefrom.

In this embodiment, a range R1 (enclosed by a dashed line in FIG. 5), in which a flick gesture can be converted into operation information for the MFP 1, is determined in advance. When a flick gesture is performed outside of the range R1, the portable terminal 2 would transmit operation information indicating that a user simply touched on the screen, to the MFP 1, without converting it to operation information.

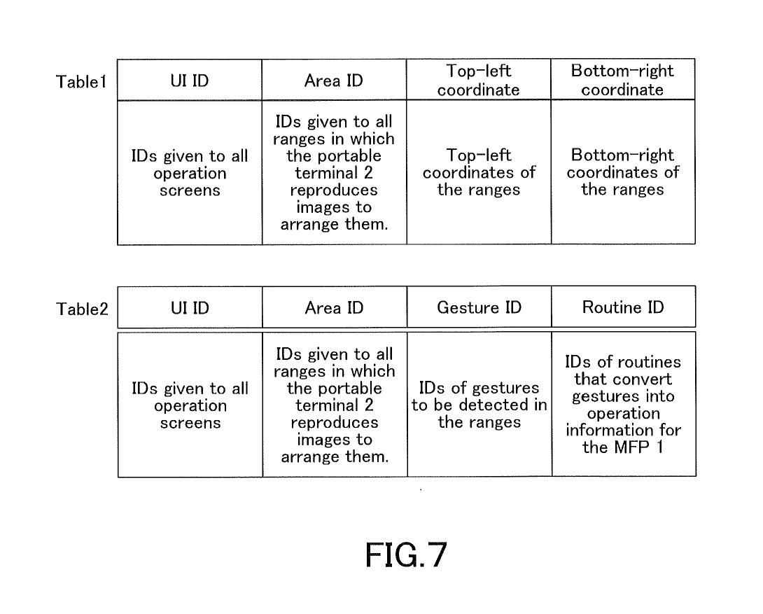

In order to transmit operation information to the MFP 1 in response to such a flick gesture, the portable terminal 2 stores in advance tables 1 and 2 as illustrated in FIG. 7 on the memory 203.

The table 1 is a table that determines ranges that are capable of detecting gestures and ranges in which the portable terminal 2 reproduces images to arrange them; the table 2 is a table containing information about gestures to be performed on the ranges determined in the table 1.

In the table 1, “UI ID” represents IDs given to all operation screens and “area ID” represents IDs given to all ranges in which the portable terminal 2 reproduces images to arrange them. “Top-left coordinate” represents top-left coordinates of the ranges in which gestures can be converted into operation information for the MFP 1; “bottom-right coordinate” represents bottom-right coordinates of the same.

The same is true on the table 2 in terms of “UI ID” and “area ID”. “Gesture ID” represents IDs of gestures that can be detected in the ranges: for example, No. 1 indicates flick gesture, No. 2 indicates synchronized scrolling (natural scrolling) gesture, No. 3 indicates pinch-out gesture, No. 4 indicates pinch-in gesture, No. 5 indicates dragging gesture, No. 6 indicates double tap gesture, and No. 0 indicates gesture not to be converted (capable of updating the display only).

“Routine ID” represents IDs of routines that convert gestures into operation information for the MFP 1.

In this embodiment, the following ranges are defined: ranges other than the range R1, in which a flick gesture can be converted into operation information for the MFP 1 correctly as mentioned above; and a range R2 (enclosed by a dashed-dotted line in FIG. 5) that updates the display. The tables 1 and 2 store necessary information for these ranges. The range R2 that updates the display is identified by gesture ID No. 0 which means the range is capable of updating the display only.

In the above-described embodiment, when a user performs a gesture on the portable terminal 2, the portable terminal 2 converts it into operation information about the operation screen, which is based on the MFP 1 rule, and transmits the operation information to the MFP 1; the MFP 1 then performs an operation as instructed with the gesture in the same manner as a user performs an ordinary non-gesture operation on the portable terminal 2. That means, even if the MFP 1 is not gesture-enabled, the portable terminal 2 displays an operation screen as instructed with a gesture performed, as a remote screen of the MFP 1 and the MFP 1 would never wrongly identify the gesture.

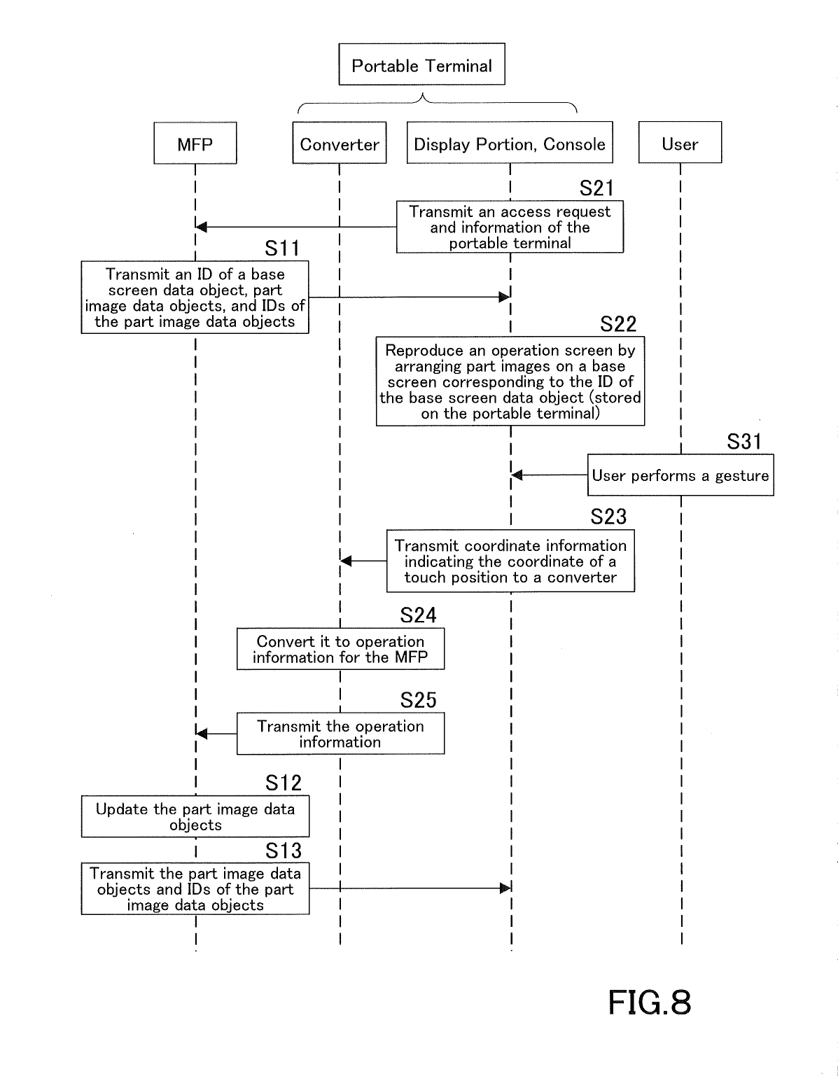

FIG. 8 is a flowchart representing information exchanges between the MFP 1 and the portable terminal 2.

In Step S21, the portable terminal 2 transmits an access request and information of the portable terminal 2 itself to the MFP 1; in Step S11, the MFP 1 transmits an ID of a base screen data object, part image data objects, and IDs of the part image data objects to the portable terminal 2, as operation screen display data. Here, the portable terminal 2 stores in advance base screen data objects for reproducing base screens of all operation screens, which is received from the MFP 1.

Upon receiving the ID of the base screen data object, the part image data objects, and the IDs of the part image data objects, the portable terminal 2 calls a base screen corresponding to the ID of the base screen data object, then reproduces an operation screen on the display portion 204a by arranging part images on the base screen, in Step S22.

Subsequently, in Step S31, a user performs a flick gesture, for example, on the operation screen with the finger; in Step S23, the portable terminal 2 transmits coordinate information indicating the coordinate of a position touched with the flick gesture, to a converter. Here, the converter is a functional part achieved by the cooperation application.

In Step S24, the converter calculates the direction in which the flick gesture is detected and a finger travel distance, converts them into operation information for the MFP 1, and transmits the operation information to the MFP 1.

The MFP 1 receives the operation information. To display an operation screen as instructed with the flick gesture, the MFP 1 updates the part image data objects in Step S12, then transmit the part image data objects and IDs of the part image data objects to the portable terminal 2 in Step S13.

Upon receiving them, the portable terminal 2 updates the operation screen by arranging the part images on the base screen.

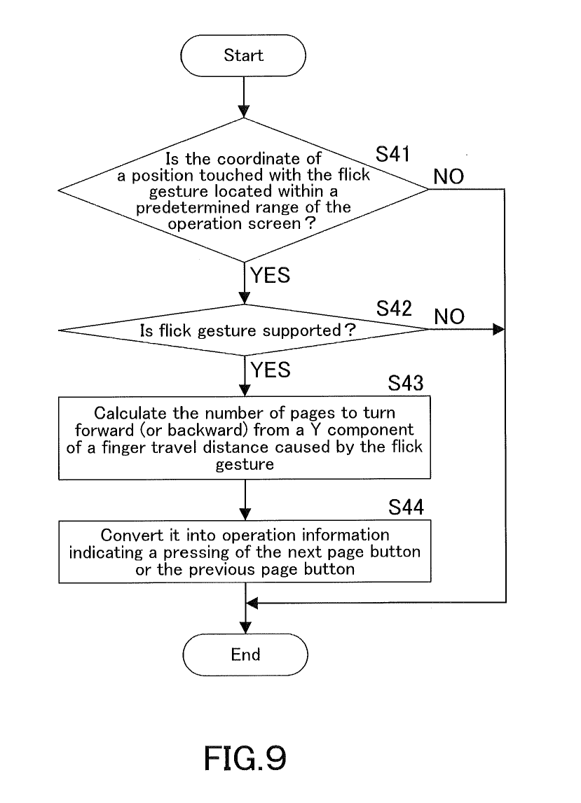

FIG. 9 is a flowchart representing an operation of the portable terminal apparatus 2, which is converting information of the flick gesture into operation information for the MFP 1. The operation is executed by the CPU 201 of the portable terminal 2 in accordance with a cooperation application or other.

In Step S41, the portable terminal 2 judges whether or not the coordinate of a position touched with the flick gesture is located within a predetermined range of the operation screen, with reference to the table 1. If it is not located within a predetermined range (NO in Step S41), the portable terminal 2 identifies the flick gesture as a button pressing and transmits operation information to the MFP 1. If it is located within a predetermined range (YES in Step S41), then in Step S42, the portable terminal 2 judges whether or not flick gesture is supported in the predetermined range, with reference to the table 2.

If it is not supported (NO in Step S42), the portable terminal 2 identifies the flick gesture as a button pressing and transmits the operation information to the MFP 1. If it is supported (YES in Step S42), the number of pages to turn forward or backward is calculated from a Y component of a finger travel distance (an up and down component of the direction in which the flick gesture is detected) in Step S43; then the flowchart proceeds to Step S44.

In Step S44, the calculated number of pages is converted into operation information indicating a pressing of the next page button 303 or the previous page button 304.

Hereinafter, another embodiment of the present invention will be described. In this embodiment, if an operation screen of the MFP 1 is composed of a plurality of pages, the MFP 1 transmits in advance operation screen display data for reproducing all these pages to the portable terminal 2; when a user performs a gesture on the portable terminal 2, the portable terminal 2 reproduces another page as instructed with the gesture on the basis of the operation screen display data for reproducing a plurality of pages. If the gesture is identified as a button pressing, the portable terminal 2 transmits operation information to the MFP 1.

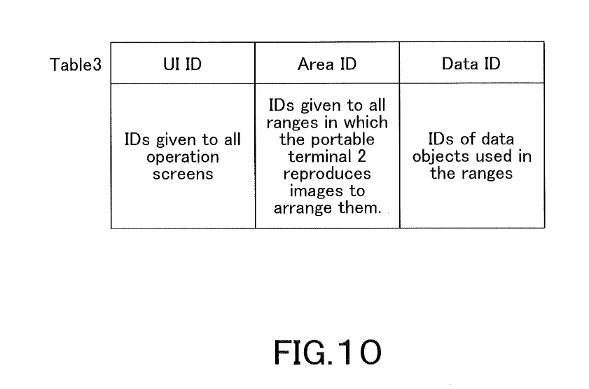

In this embodiment, in addition to the tables 1 and 2 of FIG. 7 (in this embodiment, the table 2 does not have a “Routine ID” column), the portable terminal 2 stores a table 3 as illustrated in FIG. 10.

The table 3 contains IDs of data objects used in the ranges, which is called “data ID”; the table 3 shows a correspondence between each area determined for a data object stored on the portable terminal 2 and each data object (and an ID of the data object) received from the MFP 1.

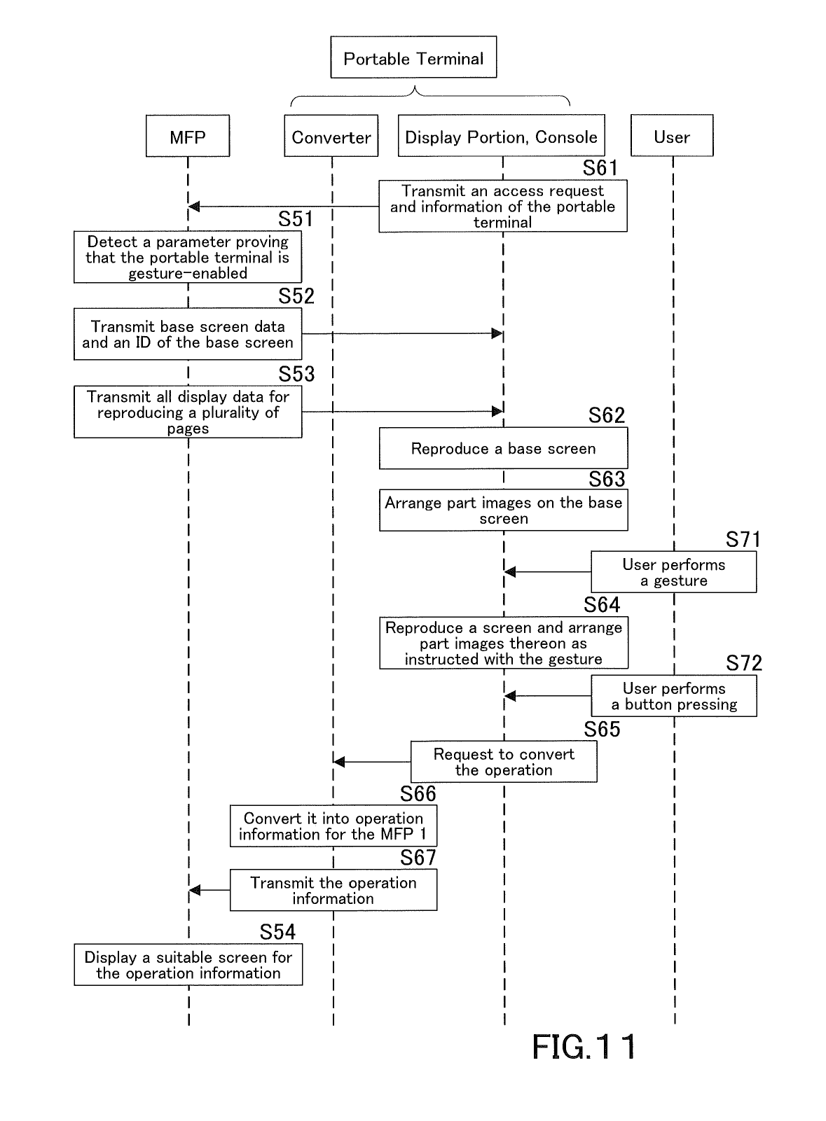

Hereinafter, information exchanges between the MFP 1 and the portable terminal 2 in this embodiment will be described with reference to a flowchart in FIG. 11.

In Step S61, the portable terminal 2 transmits an access request and information of the portable terminal 2 itself to the MFP 1; in Step S51, the MFP 1 detects a parameter proving that the portable terminal 2 is capable of generating an operation screen when a gesture is performed, from capability information of the portable terminal 2.

Subsequently, in Step S52, the MFP 1 transmits base screen data and an ID of the base screen to the portable terminal 2; then in Step S53, the MFP 1 further transmits all display data for reproducing a plurality of pages, including part image data objects and IDs of the part image data objects, to the portable terminal 2.

Here, the MFP 1 may transmit in advance base screen data objects for reproducing base screens of all operation screens and IDs of the base screen data objects to the portable terminal 2 and the portable terminal 2 stores all of them in advance. In such a case, the MFP 1 transmits an ID of a base screen to the portable terminal 2 in Step S52, and when needed, part image data objects to the portable terminal 2 in Step S53. Upon receiving an ID of a base screen and part image data objects, the portable terminal 2 calls a base screen corresponding to the ID of the base screen, then reproduces an operation screen by arranging part images on the base screen. In this configuration, the MFP 1 does not have to transmit base screen data every time it is needed, which would ensure a smooth traffic flow between the MFP 1 and the portable terminal 2.

After receiving all the data, the portable terminal 2 calls a base screen on the display portion 204a in Step S62, then arranges part images on the base screen in Step S63.

Subsequently, in Step S71, a user performs a flick gesture, for example, on the operation screen with the finger. In Step S64, the portable terminal 2 reproduces a screen as instructed with the gesture, e.g., a next page or a previous page, by arranging part images on the base screen on the basis of the display data for reproducing a plurality of pages, which is received from the MFP 1.

In Step S72, a user performs a button pressing on the operation screen reproduced on the portable terminal 2; in Step S65, the portable terminal 2 requests the converter, which is a functional part achieved by the cooperation application, to convert the operation. The converter converts the button pressing into operation information for the MFP 1 in Step S66, and transmits the operation information to the MFP 1 in Step S67.

In Step S54, the MFP 1 displays a screen that is matching the operation information or performs an operation that is matching the operation information.

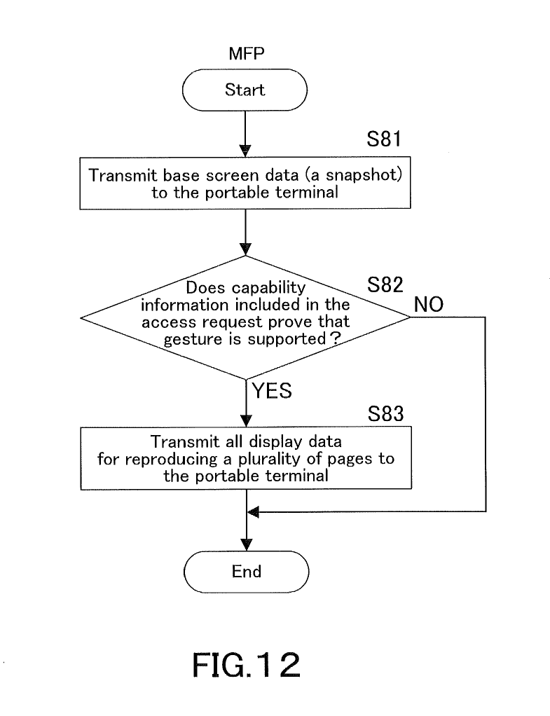

FIG. 12 is a flowchart representing an operation of the MFP 1 in the aforementioned embodiment of FIG. 11.

In Step S81, the MFP 1 transmits base screen data (a snapshot) and an ID of the bases screen data to the portable terminal 2 in response to an access request therefrom; then in Step S82, the MFP 1 judges whether or not capability information included in the access request proves that gesture is supported, i.e.; whether or not the portable terminal 2 is capable of generating an operation screen when a gesture is performed. In a reverse manner, the flowchart may proceed to Step S82 for the judgment and then to Step S81 for the screen data transmission.

In Step S82, if capability information does not prove that gesture is supported (NO in Step S82), the flowchart terminates. If it proves (YES in Step S82), the MFP 1 transmits all display data for reproducing a plurality of pages to the portable terminal 2 in Step S83.

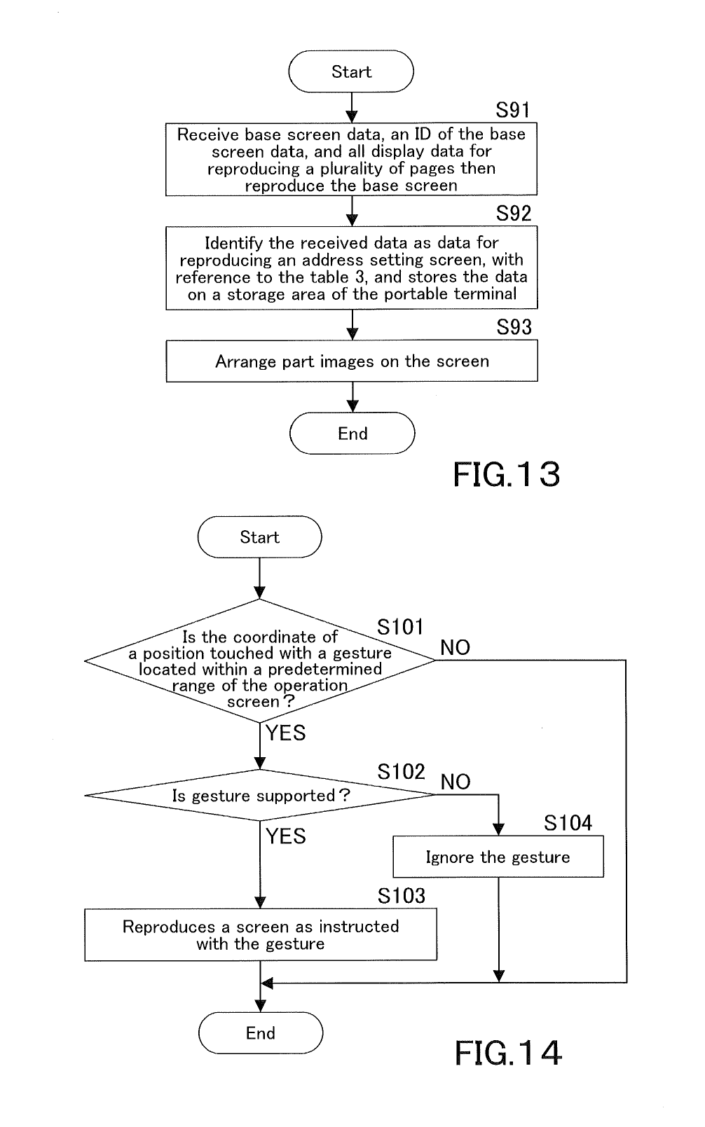

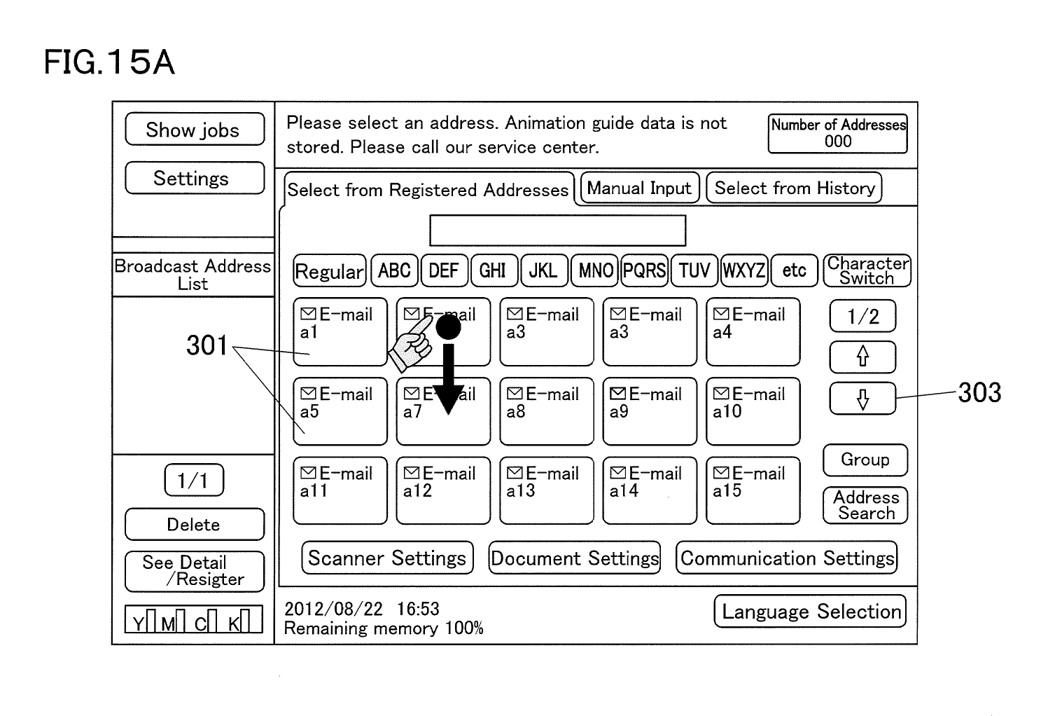

FIGS. 13 and 14 are flowcharts representing an operation of the portable terminal 2 in the aforementioned embodiment of FIG. 11; more specifically, FIG. 13 is a flowchart starting when data is received from the MFP 1 and FIG. 14 is a flowchart starting when a gesture is performed. These operations are executed by the CPU 201 of the portable terminal 2 in accordance with a cooperation application or other.

In Step S91 of FIG. 13, the portable terminal 2 receives base screen data for reproducing a base screen, an ID of the base screen data, and all display data for reproducing a plurality of pages based on the base screen, then reproduces the base screen on the display portion 204a.

In Step S92, the portable terminal 2 identifies the received data as data for reproducing an address setting screen, with reference to the table 3, and stores the data on a storage area of the portable terminal 2. Then in Step S93, the portable terminal 2 arranges part images on the base screen.

In Step S101 of FIG. 14, the portable terminal 2 judges whether or not the coordinate of a position touched with a gesture performed (a flick gesture, for example) is located within a predetermined range of the operation screen, with reference to the table 1. If it is not located within a predetermined range (NO in Step S101), the portable terminal 2 identifies the flick gesture as a button pressing and transmits operation information to the MFP 1. If it is located within a predetermined range (YES in Step S101), then in Step S102, the portable terminal 2 judges whether or not gesture is supported in the predetermined range, with reference to the table 2.

If it is supported (YES in Step S102), the portable terminal 2 reproduces a screen on the display portion 204a as instructed with the flick gesture in Step S103. If it is not supported (NO in Step S102), the portable terminal 2 ignores the flick gesture in Step S104: the portable terminal 2 does not perform any operation.

In the aforementioned embodiment, when a gesture is performed on the operation screen, the portable terminal 2 reproduces another page on the display portion 204a as instructed with the gesture; when an operation button is pressed on the operation screen, the portable terminal 2 transmits operation information to the MFP 1 as it did conventionally. That means, even if the MFP 1 is not gesture-enabled, the portable terminal 2 displays an operation screen as instructed with a gesture performed and the MFP 1 would never wrongly identify the gesture.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. A cooperative image processing system comprising an image processing apparatus and a portable terminal apparatus, the image processing apparatus and the portable terminal apparatus being capable of connecting to each other,
the image processing apparatus comprising a transmitter that transmits operation screen display data for reproducing an operation screen of the image processing apparatus to the portable terminal apparatus to allow the portable terminal apparatus to reproduce the operation screen, the portable terminal apparatus being connected to the image processing apparatus,
the portable terminal apparatus comprising:
a receiver that receives the operation screen display data from the image processing apparatus;
a display portion that displays the operation screen of the image processing apparatus on the basis of the operation screen display data received by the receiver;
a console that accepts a user gesture instruction as input;
a memory that records a predetermined conversion rule in accordance with which the user gesture instruction input via the console can be converted into operation information about the operation screen of the image processing apparatus, the operation screen displayed on the display portion;
a converter that converts the user gesture instruction into operation information about the operation screen of the image processing apparatus in accordance with the conversion rule, when the user gesture instruction is input via the console while the operation screen is displayed on the display portion; and
a transmitter that transmits the operation information about the operation screen, the operation information being obtained by the converter,
the image processing apparatus further comprising a controller that performs an operation being matching the operation information, the operation information being received from the portable terminal apparatus.

2. A cooperative image processing system comprising an image processing apparatus and a portable terminal apparatus, the image processing apparatus and the portable terminal apparatus being capable of connecting to each other,
the image processing apparatus comprising a transmitter that transmits operation screen display data for reproducing an operation screen of the image processing apparatus or a plurality of pages composing the operation screen to the portable terminal apparatus to allow the portable terminal apparatus to reproduce the operation screen or the pages, respectively, the portable terminal apparatus being connected to the image processing apparatus,
the portable terminal apparatus comprising:
a receiver that receives the operation screen display data from the image processing apparatus;
a display portion that displays the operation screen of the image processing apparatus on the basis of the operation screen display data received by the receiver;
a console that accepts a user gesture instruction as input;
a screen reproduction portion that reproduces another page on the display portion as prompted by the user gesture instruction, on the basis of the operation screen display data for reproducing the pages, the operation screen display data being received from the image processing apparatus, when the user gesture instruction is input via the console while any one of the pages is displayed on the display portion; and
a transmitter that transmits operation information indicating a button pressing to the image processing apparatus, when an operation button is pressed on the operation screen displayed on the display portion,
the image processing apparatus further comprising a controller that performs an operation being matching the operation information, the operation information being received from the portable terminal apparatus.

3. A cooperative image processing method to be implemented by a cooperative image processing system, the cooperative image processing system comprising an image processing apparatus and a portable terminal apparatus, the image processing apparatus and the portable terminal apparatus being capable of connecting to each other,
the cooperative image processing method comprising the following step of the image processing apparatus: transmitting operation screen display data for reproducing an operation screen of the image processing apparatus to the portable terminal apparatus to allow the portable terminal apparatus to reproduce the operation screen,
the portable terminal apparatus comprising:
a display portion;
a console that accepts a user gesture instruction as input; and
a memory that records a predetermined conversion rule in accordance with which the user gesture instruction input via the console can be converted into operation information about the operation screen of the image processing apparatus, the operation screen being displayed on the display portion,
the cooperative image processing method further comprising the following steps of the portable terminal apparatus:
receiving the operation screen display data from the image processing apparatus;
displaying the operation screen of the image processing apparatus on the display portion on the basis of the operation screen display data received therefrom;
converting the user gesture instruction into operation information about the operation screen of the image processing apparatus in accordance with the conversion rule, when the user gesture instruction is input via the console while the operation screen is displayed on the display portion; and
transmitting the operation information about the operation screen, the operation information being obtained as a result of the conversion,
the cooperative image processing method further comprising the following step of the image processing apparatus: performing an operation being matching the operation information, the operation information being received from the portable terminal apparatus.

4. The cooperative image processing method as recited in claim 3, wherein the conversion rule defines relationships among the following elements: a finger travel distance and a finger moving direction which are calculated from a gesture starting point and a gesture ending point; whether to turn pages forward or backward; and the number of pages to turn forward or backward.

5. The cooperative image processing method as recited in claim 3, wherein:
while the operation screen is composed of a base screen and a part image to be put on the base screen, the operation screen display data includes a base screen data object for reproducing the base screen and a part image data object for reproducing the part image; and
when receiving the part image data object from the image processing apparatus, the portable terminal apparatus reproduces the operation screen by arranging the part image on the base screen on the basis of the part image data object received therefrom and the base screen data objects, the base screen data objects being received in advance from the image processing apparatus and stored in advance on the portable terminal apparatus.

6. A cooperative image processing method to be implemented by a cooperative image processing system, the cooperative image processing system comprising an image processing apparatus and a portable terminal apparatus, the image processing apparatus and the portable terminal apparatus being capable of connecting to each other,
the cooperative image processing method comprising the following step of the image processing apparatus:
transmitting operation screen display data for reproducing an operation screen of the image processing apparatus or a plurality of pages composing the operation screen to the portable terminal apparatus to allow the portable terminal apparatus to reproduce the operation screen or the pages, respectively, the portable terminal apparatus being connected to the image processing apparatus,
the cooperative image processing method comprising the following steps of the portable terminal apparatus:
receiving the operation screen display data from the image processing apparatus;
displaying the operation screen of the image processing apparatus on a display portion on the basis of the operation screen display data received therefrom;
reproducing another page on the display portion as prompted by a user gesture instruction, on the basis of the operation screen display data for reproducing the pages, the operation screen display data being received from the image processing apparatus, when the user gesture instruction is input via a console while any one of the pages is displayed on the display portion; and
transmitting operation information indicating a button pressing to the image processing apparatus, when an operation button is pressed on the operation screen displayed on the display portion,
the cooperative image processing method further comprising the following step of the image processing apparatus: performing an operation being matching the operation information, the operation information being received from the portable terminal apparatus.

7. The cooperative image processing method as recited in claim 6, wherein the image processing apparatus transmits the operation screen display data for reproducing the pages if receiving a parameter from the portable terminal apparatus, the parameter proving that the portable terminal apparatus is capable of generating an operation screen when the user gesture instruction is input via the console.

8. The cooperative image processing method as recited in claim 6, wherein:
while the operation screen is composed of a base screen and a part image to be put on the base screen, the operation screen display data includes a base screen data object for reproducing the base screen and a part image data object for reproducing the part image; and
when receiving the part image data object from the image processing apparatus, the portable terminal apparatus reproduces the operation screen by arranging the part image on the base screen on the basis of the part image data object received therefrom and the base screen data objects, the base screen data objects being received in advance from the image processing apparatus and stored in advance on the portable terminal apparatus.

9. A portable terminal apparatus comprising:
a connecting portion that connects the portable terminal apparatus to an image processing apparatus;
a receiver that receives operation screen display data for reproducing an operation screen of the image processing apparatus from the image processing apparatus to which the portable terminal apparatus is connected by the connecting portion;
a display portion that displays the operation screen of the image processing apparatus on the basis of the operation screen display data received by the receiver;
a console that accepts a user gesture instruction as input;
a memory that records a predetermined conversion rule in accordance with which the user gesture instruction input via the console can be converted into operation information about the operation screen of the image processing apparatus, the operation screen displayed on the display portion;
a converter that converts the user gesture instruction into operation information about the operation screen of the image processing apparatus in accordance with the conversion rule, when the user gesture instruction is input via the console while the operation screen is displayed on the display portion; and
a transmitter that transmits the operation information about the operation screen, the operation information being obtained by the converter.

10. The portable terminal apparatus as recited in claim 9, wherein the conversion rule defines relationships among the following elements: a finger travel distance and a finger moving direction which are calculated from a gesture starting point and a gesture ending point; whether to turn pages forward or backward; and the number of pages to turn forward or backward.

11. The portable terminal apparatus as recited in claim 9, wherein:
while the operation screen is composed of a base screen and a part image to be put on the base screen, the operation screen display data includes a base screen data object for reproducing the base screen and a part image data object for reproducing the part image; and
when receiving the part image data object from the image processing apparatus, the portable terminal apparatus reproduces the operation screen by arranging the part image on the base screen on the basis of the part image data object received therefrom and the base screen data objects, the base screen data objects being received in advance from the image processing apparatus and stored in advance on the portable terminal apparatus.

12. A non-transitory computer-readable recording medium storing a cooperative image processing program for a computer of a portable terminal apparatus,
the portable terminal apparatus comprising:
a display portion;
a console that accepts a user gesture instruction as input; and
a memory that records a predetermined conversion rule in accordance with which the user gesture instruction input via the console can be converted into operation information about an operation screen of an image processing apparatus, the operation screen being displayed on the display portion,
the cooperative image processing program to make the computer execute:
connecting the portable terminal apparatus to the image processing apparatus;
receiving operation screen display data for reproducing the operation screen of the image processing apparatus from the image processing apparatus to which the portable terminal apparatus is connected;
displaying the operation screen of the image processing apparatus on the display portion on the basis of the operation screen display data received therefrom;
converting the user gesture instruction into operation information about the operation screen of the image processing apparatus in accordance with the conversion rule, when the user gesture instruction is input via the console while the operation screen is displayed on the display portion; and
transmitting the operation information about the operation screen, the operation information being obtained as a result of the conversion.

13. The non-transitory computer-readable recording medium as recited in claim 12, wherein the conversion rule defines relationships among the following elements: a finger travel distance and a finger moving direction which are calculated from a gesture starting point and a gesture ending point; whether to turn pages forward or backward; and the number of pages to turn forward or backward.

14. The non-transitory computer-readable recording medium as recited in claim 12, wherein:
while the operation screen is composed of a base screen and a part image to be put on the base screen, the operation screen display data includes a base screen data object for reproducing the base screen and a part image data object for reproducing the part image; and
when receiving the part image data object from the image processing apparatus, the portable terminal apparatus reproduces the operation screen by arranging the part image on the base screen on the basis of the part image data object received therefrom and the base screen data objects, the base screen data objects being received in advance from the image processing apparatus and stored in advance on the portable terminal apparatus.

15. A portable terminal apparatus comprising:
a connecting portion that connects the portable terminal apparatus to an image processing apparatus;
a receiver that receives operation screen display data for reproducing an operation screen of the image processing apparatus or a plurality of pages composing the operation screen from the image processing apparatus, the image processing apparatus being connected to the portable terminal apparatus;
a display portion that displays the operation screen of the image processing apparatus on the basis of the operation screen display data received by the receiver;
a console that accepts a user gesture instruction as input;
a screen reproduction portion that reproduces another page on the display portion as prompted by the user gesture instruction, on the basis of the operation screen display data for reproducing the pages, the operation screen display data being received from the image processing apparatus, when the user gesture instruction is input via the console while any one of the pages is displayed on the display portion; and
a transmitter that transmits operation information indicating a button pressing to the image processing apparatus, when an operation button is pressed on the operation screen displayed on the display portion.

16. The portable terminal apparatus as recited in claim 15, wherein:
while the operation screen is composed of a base screen and a part image to be put on the base screen, the operation screen display data includes a base screen data object for reproducing the base screen and a part image data object for reproducing the part image; and
when receiving the part image data object from the image processing apparatus, the portable terminal apparatus reproduces the operation screen by arranging the part image on the base screen on the basis of the part image data object received therefrom and the base screen data objects, the base screen data objects being received in advance from the image processing apparatus and stored in advance on the portable terminal apparatus.

17. A non-transitory computer-readable recording medium storing a cooperative image processing program to make a computer of a portable terminal apparatus execute:
connecting the portable terminal apparatus to an image processing apparatus;
receiving operation screen display data for reproducing an operation screen of the image processing apparatus or a plurality of pages composing the operation screen from the image processing apparatus, the image processing apparatus being connected to the portable terminal apparatus;
displaying the operation screen of the image processing apparatus on a display portion on the basis of the operation screen display data received therefrom;
reproducing another page on the display portion as prompted by a user gesture instruction, on the basis of the operation screen display data for reproducing the pages, the operation screen display data being received from the image processing apparatus, when the user gesture instruction is input via a console while any one of the pages is displayed on the display portion; and
transmitting operation information indicating a button pressing to the image processing apparatus, when an operation button is pressed on the operation screen displayed on the display portion.

18. The non-transitory computer-readable recording medium as recited in claim 17, wherein:
while the operation screen is composed of a base screen and a part image to be put on the base screen, the operation screen display data includes a base screen data object for reproducing the base screen and a part image data object for reproducing the part image; and
when receiving the part image data object from the image processing apparatus, the portable terminal apparatus reproduces the operation screen by arranging the part image on the base screen on the basis of the part image data object received therefrom and the base screen data objects, the base screen data objects being received in advance from the image processing apparatus and stored in advance on the portable terminal apparatus.
